(19) United States
(12) Patent Application Publication
(10) Pub. No.: US 2009/0100340 A1
(43) Pub. Date: Apr. 16, 2009

(54) ASSOCIATIVE INTERFACE FOR PERSONALIZING VOICE DATA ACCESS

(75) Inventors: Timothy S. Paek, Sammamish, WA (US); Alice Jane Bernheim Brush, Bellevue, WA (US); Yun-Cheng Ju, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/870,039

(22) Filed: Oct. 10, 2007

(51) Int. Cl. G06F 3/16; G06F 21/00; G10L 13/08

(52) U.S. Cl. 715/728; 704/260; 726/21

(57) ABSTRACT

The claimed subject matter according to one aspect provides systems and/or methods that effectuate user development, customization, or utilization of dynamically configurable dialogue flow systems. The system can include devices and components that employ data associated with a user to retrieve navigation panes unique with respect to the user, scans the navigation panes and identifies adjustable attributes, utilizes the adjustable attributes to generate voice prompts communicated to the user via handheld devices, the user in reply to the voice prompts utters personalized responses associated with the voice prompts, and based at least on the personalized responses initiates actions associated with the adjustable attributes.

### BACKGROUND

From up-to-date traffic information to looking up information on multilingual web-based encyclopedias or reading e-mail, for example, there are many ways people can make use of access to information on the Internet while they are mobile. Although devices currently exist that allow such access, including wireless handheld devices that support a plethora of wireless information services, these devices have not been met with universal acclaim or been broadly adopted. Thus, despite the potential convenience of mobile access to information on the Internet, hurdles such as the need for expensive hardware and service plans, poor readability, input devices, and slow latencies deter many consumers from even trying. In response, telecommunication and Internet providers have been expanding their network bandwidth, and hardware manufacturers have been expanding the computational power and functionality of mobile devices.

Building spoken dialogue systems is a growing market. Hundreds of systems are typically deployed each year handling everything from directory assistance, which can be open to all consumers, to business form-filing which generally are proprietary. Authoring spoken dialogue systems that are robust enough to handle calls from a large population of users can be extremely challenging, and as such, a set of “best practices” has evolved and developed for voice user interface (VUI) design. At the acoustic level, systems have to deal with potentially wide variability in pronunciation and accent. At the language modeling level, systems need to anticipate and cover everything that a user might say in their grammars. And, at the dialogue level, systems need to gracefully recover from misunderstandings and non-understandings, while at the same time dealing with users who can become frustrated.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Despite the potential convenience of having mobile access to information on the Internet, many hurdles can deter users, such as the need for expensive hardware, software, and service plans, input difficulties, and slow latencies. A simple alternative to more powerful networks or mobile devices (e.g., portable media players, Personal Digital Assistants (PDAs), cell phones, smart phones, laptop computers, notebook computers, consumer devices/appliances, portable industrial automation devices, automotive components, aviation components, hand-held devices, desktop computers, server class computing platforms, multimedia and Internet enabled mobile phones, and the like) can be a voice portal where users interact with a spoken dialogue system to obtain information. Nevertheless, authoring such a dialogue system for a large population and cross-section of people can pose many challenges at the acoustic, linguistic, language modeling, and dialogue levels. To this end, the claimed subject matter as elucidated and explicated herein can provide a platform for accessing information on the Internet from any mobile device that overcomes the aforementioned challenges by allowing users to personalize their own dialogue systems. By giving users the ability to access and modify their own dialogue system through a website, for example, the subject matter as claimed in accordance with an illustrative aspect can convey to such users the correspondence between graphical user interfaces (GUIs) and voice user interfaces (VUIs). Supporting this style of interaction, where “What You See Is What You Hear (WYSIWYH)” can make it easier for users to interact with dialogue systems using mobile devices, such as cell phones, for example.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates and facilitates user development, customization, or utilization of dynamic dialogue flow systems in accordance with the claimed subject matter.

FIG. 2 provides a more detailed depiction of a portal component in accordance with one aspect of the claimed subject matter.

FIG. 3 provides a more detailed depiction of an illustrative personalization component that effectuates and facilitates user development, customization, or utilization of dynamic dialogue flow systems in accordance with an aspect of the claimed subject matter.

FIG. 4 provides illustration of a navigation pane that effectuates and facilitates user development, customization, or utilization of dynamic dialogue flow systems in accordance with an aspect of the claimed subject mater.

FIG. 5 illustrates a system implemented on a machine that effectuates and facilitates user development, customization, or utilization of dynamic dialogue flow systems in accordance with an aspect of the claimed subject matter.

FIG. 6 provides a further depiction of a machine implemented system that effectuates and facilitates user development, customization, or utilization of dynamic dialogue flow systems in accordance with an aspect of the subject matter as claimed.

FIG. 7 illustrates yet another aspect of the machine implemented system that effectuates and facilitates user development, customization, or utilization of dynamic dialogue flow systems in accordance with an aspect of the claimed subject matter.

FIG. 8 depicts a further illustrative aspect of the machine implemented system that effectuates and facilitates user development, customization, or utilization of dynamic dialogue flow systems in accordance with an aspect of the claimed subject matter.

FIG. 9 illustrates another illustrative aspect of a system implemented on a machine that effectuates and facilitates user development, customization, or utilization of dynamic dialogue flow systems in accordance of yet another aspect of the claimed subject matter.

FIG. 10 depicts yet another illustrative aspect of a system that effectuates and facilitates user development, customization, or utilization of dynamic dialogue flow systems in accordance with an aspect of the subject matter as claimed.

FIG. 11 illustrates a flow diagram of a machine implemented methodology that effectuates and facilitates user development, customization, or utilization of dynamic dialogue flow systems in accordance with an aspect of the claimed subject matter.

FIG. 12 depicts a further illustration of a navigation pane that facilitates and effectuates user development, customization, or utilization of dynamic flow systems in accordance with one aspect of the claimed subject matter.

FIG. 13 provides further depiction of a navigation pane that facilitates and effectuates user development, customization, or utilization of dynamic flow systems in accordance with a further aspect of the claimed subject matter.

FIG. 14 provides another illustration of a navigation pane that facilitates and effectuates user development, customization, or utilization of dynamic flow systems in accordance with one aspect of the claimed subject matter.

FIG. 15 illustrates a block diagram of a computer operable to execute the disclosed system in accordance with an aspect of the claimed subject matter.

FIG. 16 illustrates a schematic block diagram of an exemplary computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

Through trial and error, developers have found that the most effective way to deal with challenges, such as, variability in pronunciation and accent, covering everything that users might say in their grammars, gracefully recovering from misunderstandings and non-understandings, is to limit what users can say at any time and to guide them to say just those things. This has been called directed dialogue. Much of voice user interface (VUI) design today is focused on how to create effective directed dialogue. Without a doubt, spoken language understanding (SLU), where users can express themselves using natural language which then gets mapped to the semantic concepts a system understands, affords more naturalistic interaction. However, directed dialogues tend to exhibit higher recognition accuracy and consequently more task completions. Because task completion is ultimately what drives developers, the architecture of most deployed systems is dominated by directed dialogue using fixed grammars, although spoken language understanding (SLU) can sometimes be incorporated for specific tasks such as call routing.

Unfortunately, using directed dialogues is typically not a panacea. In many cases, companies spend more time tuning a directed dialogue system after it has been deployed then building it in the first place—that is, before they knew who would be using it and how. Thus, the claimed subject matter, instead of building systems keyed to all users, provides a platform that allows users to create their own dialogue systems. Such a platform removes the need for tuning or optimizing across all users. Additionally, the subject matter as claimed can focus on the much simpler task of adapting to a particular user.

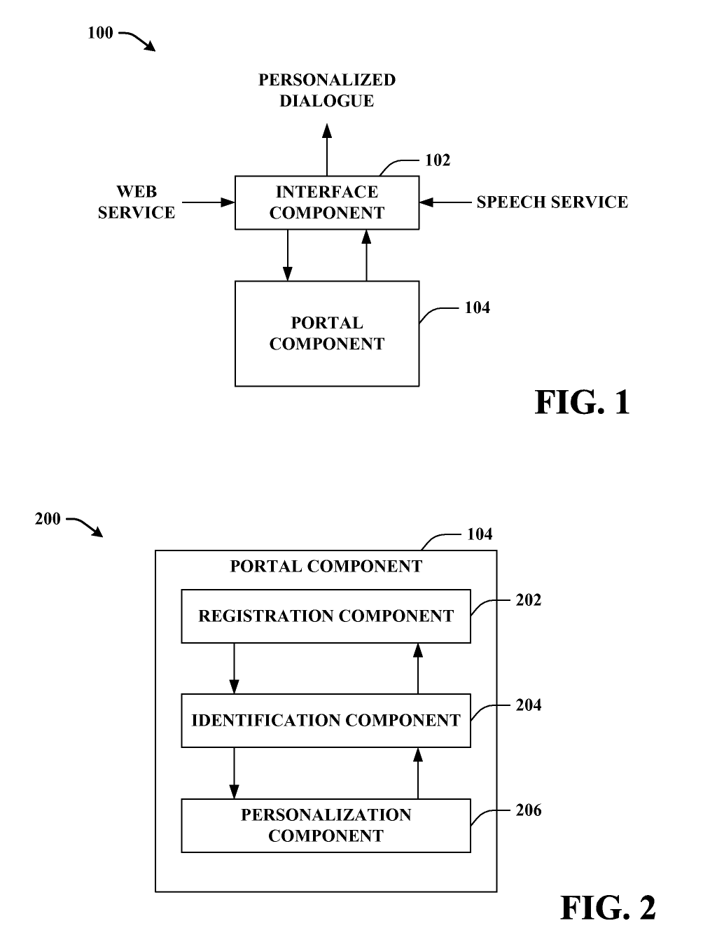

FIG. 1 depicts a system 100 that allows users (e.g., human and/or machine) to develop, customize, and utilize their own dialogue systems. System 100 typically can be implemented on a server based computing platform as such implementation can leverage all of the computational power of servers to quickly process data and return results to users. However as will be readily appreciated by those cognizant in the art, any machine that includes a processor can utilized to effectuate system 100. Illustrative machines that can be employed without limitation can include laptop computers, Tablet PCs, handheld computers, desktop computers, personal digital assistants (PDAs), industrial and consumer devices and/or appliances, mobile devices, Smart phones, cell phones, and the like.

System 100 can include an interface component 102 (hereinafter referred to as “interface 102”) that can receive and/or obtain information from web services (e.g., websites) and/or speech services (e.g., telephony services). Such information solicited and/or received from web services and/or speech services can be utilized to register and personalize nearly every aspect of a user created dialogue system. Interface 102 can also receive data from a multitude of other sources, such as, for example, data associated with a particular client application, service, user, client, and/or entity involved with a portion of a transaction and thereafter can convey the received information to portal component 104. Additionally, interface 102 can receive information from portal component 104 which can then be communicated to users in the form of personalized dialogue (e.g., personalized call/query and response attributes), for example. It should be noted that the personalized dialogue communicated to users can include not only data on and/or related to, the Internet, but also automatic speech recognition (ASR) as well.

Interface 102 can provide various adapters, connectors, channels, communication pathways, etc. to integrate the various components included in system 100 into virtually any operating system and/or database system and/or with one another. Additionally, interface 102 can provide various adapters, connectors, channels, communication modalities, etc. that can provide for interaction with various components that can comprise system 100, and/or any other component (external and/or internal), data and the like associated with system 100.

Portal component 104 can provide mechanisms and facilities to allow users (e.g., human and/or machine) to register with a web service and/or a speech service and thereafter receive a user account. During registration users can associate a unique identifier (e.g., a username, telephone number, a system assigned identifier, etc.) with their account as well as create and/or receive a password (e.g., personal identification number (PIN)) for security purposes so that when users access system 100, and in particular portal component 104, they can be identified using their unique identifier (e.g., where a telephone number is utilized, system 100 can identify the user through use of a caller ID functionality). Although portal component 104 can provide a default experience, through the web service or speech service, users can nevertheless personalized and customize every major aspect of their dialogue system. Users can not only subscribe to the data services (e.g., Internet services) they want, but can also customize the prompts, voice commands, and even dialogue flow.

When users first login to system 100, and gain access to portal component 104, they can be presented and/or perceive (e.g., see, hear, touch, . . . ) a “Start Page” that can show data services currently available to them (e.g., services to which they have subscribed). Each “Page” can correspond to a state in a dialogue flow. Consequently, the title of the “Start Page” can contain what a user would hear as the prompt for the start of the dialogue when they login (e.g., through a mobile hand held device such as a cell phone, Smart phone, laptop computer, personal digital assistant (PDA), and the like). The title of the “Start Page” can be adjustable so that users can customize the title to whatever they desire (e.g., the system can say “Welcome Supreme Master” instead of “Welcome Tim”). Additionally, portal component 104 can be utilized to effectuate correspondences between possible graphical user interface (GUI) actions that can be taken on web pages with utterances that the user can make in response to prompts. For example, if a user wanted to access a first service (e.g., My Application 1) the user can customize the action by just stating (e.g., speaking) “Application one” instead of saying “Go to My Application 1”. This kind of correspondence between graphical user interface (GUI) and voice user interface (VUI) and visa versa can be described as What You See Is What You Hear (WYSIWYH). Scanning a web page, for example, from top to bottom can therefore visually convey to the user what the system is going to say and what they can say in response. Additionally, as users add new services or delete obsolete services, web pages can be added to or removed from a user's navigation structure. This subsequently adds or deletes states to or from a user's dialogue flow.

Portal component 104 can persist a user's navigation structure and all adjustable content on each web page as user data. Thus, when a user calls a speech service (e.g., a telephony front-end), portal component 104 can take the stored user data and automatically generate spoken dialogue on the fly, using the navigation structure as a dialogue call flow and adjustable content as part of its grammars. It should be noted that if system 100 had only been a speech service front-end (e.g., telephony server) would have been like any other voice portal, where users have to learn how the system works by interacting with it in real-time. But because system 100 has both web services functionality as well as speech mechanisms, users can transfer their web experience over to interacting with the dialogue system, which they built and personalized themselves. Accordingly, users will generally have an easier time interacting with the claimed subject matter because they will typically recognize their own prompts and because they can use their own language.

FIG. 2 provides a more detailed depiction 200 of portal component 104 in accordance with an aspect of the claimed subject matter. Portal component 104 can include registration component 202 that allows users (human and/or machine) to register with web services and/or speech services and thereafter to receive account information. During registration users can associate a unique identifier (e.g., a username, telephone number, a system assigned identifier, etc.) with their account as well as create and/or receive a password (e.g., personal identification number (PIN)) for security purposes so that when users subsequently access the system they can be identified using their unique identifier.

Further, portal component 104 can also include an identification component 204 that can utilize biometric devices and facilities (e.g., voice pattern recognition, retinal scan, facial recognition, finger print analysis, and the like) to verify user identity. Such biometric data can be associated with registered users, for example, through a previously assigned or allocated account identifier (e.g., name, telephone number, randomly generated unique identifiers, etc.).

Portal component 104 can further include personalization component 206 that can permit identified users to customize every aspect of their dialogue interaction with the system 100. Personalization component 206 can allow users to modify correspondences and/or associations between data services to which a user has subscribed and utterances (e.g., voice commands) employed to initiate actions associated with such data services. For example, if a user wished to access a data service (e.g., My Notes) he or she could change the mnemonic from one form to another (e.g., from “My Notes” to “Richard's Notes”, “Captain's Log”, or “Notes about End Times”, . . . ). In such a manner, personalization component 206 can allow users to create a dialogue flow (e.g., sets of calls/prompts and responses) that allow users to seamlessly navigate through data services through mnemonic devices of their own creation.

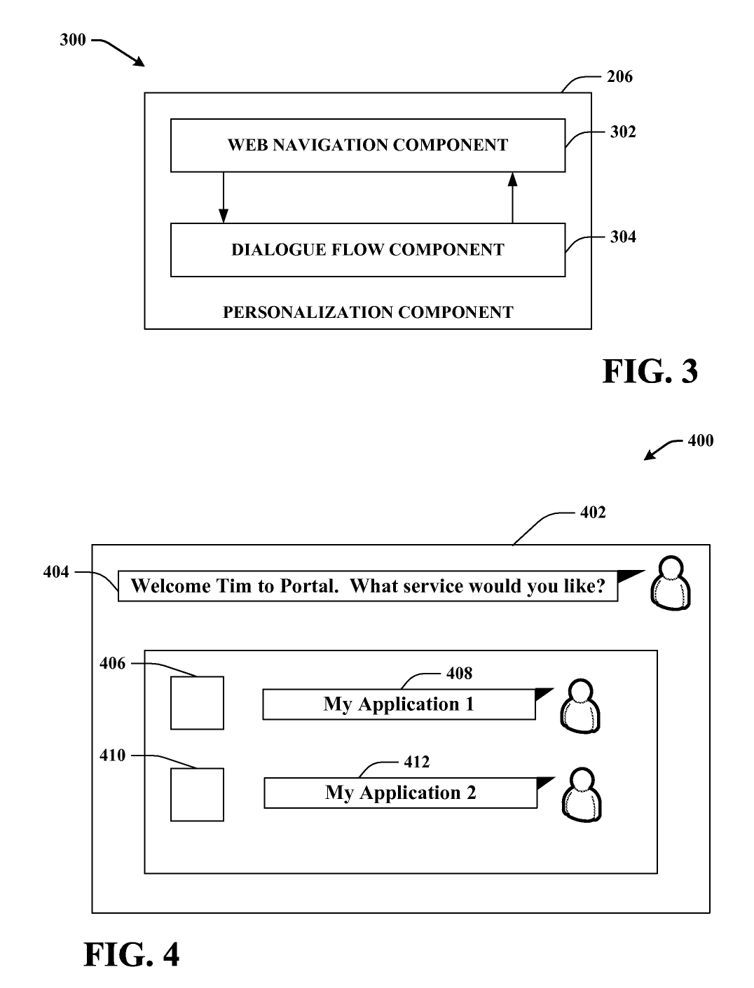

FIG. 3 provides more detailed illustration 300 of personalization component 206 in accordance with an aspect of the claimed subject matter. Personalization component 206 can include web navigation component 302 that consult with previously persisted or contemporaneously constructed web navigation structures (e.g., web pages or a series/sequence of web pages corresponding to a dialogue flow wherein each web page). For example, the initial commencement point of a dialogue flow can be a web page wherein each web page corresponds to a state in a dialogue flow. Accordingly, the first page (or initial page) can contain what the user would perceive (e.g., hear, see, touch, . . . ) as a prompt for the start of the dialogue when a user (machine and/or human) commences communication via a device, such as, for example, server class machines, personal desktop computers, Smart phones, cell phones, industrial automation devices, consumer devices, laptop computers, multimedia Internet enabled phones, notebook computers, Tablet PCs, personal digital assistants (PDAs), any handheld device that includes a processor, and/or that can include a processor, and/or any device capable of facilitating and/or effectuating wired and/or wired communication with system 100. The possible actions that can be taken can also be presented on this initial page as choices that the user can utter in response to prompts. For instance, if a user wished to access a service (e.g., Stock Market quotations) the user can initiate interaction with such a service by enunciating a service mnemonic known to, and/or predetermined by (or in the alternative a system specified default name), the user (e.g., “market quotes”). This kind of correspondence and association between the spoken utterance (via a voice user interface (VUI)) and actions presented as a series of states presented in the metaphor of web pages, for example, can be referred to a What You See Is What You Hear (WYSIWYH). Accordingly, web navigation component 302 can scan the web pages transitioning between states as required. At each transitioned state dialogue flow component 304 can be employed to automatically generate spoken dialog on the fly, utilizing web navigation structure supplied by web navigation component 302 as the dialogue flow and adjustable content (e.g., “market quotes”) as part of its grammars.

FIG. 4 provides depiction 400 of an illustrative navigation pane 402 that can be employed in accordance with an aspect of the claimed subject matter. Navigation pane 402 can correspond to an initial state in a dialogue flow, for example. As illustrated, navigation pane 402 can include a user amendable prompt/bubble 404 that a user would, for example, hear when navigation pane 402 is accessed. By allowing users to visually inspect and adjust such amendable prompts/bubbles (e.g., 404) users are essentially priming themselves on what they would expect to hear when they access navigation pane 402 through some combination of auditory/visual interface, such as a telephone, for example. In this instance system 100 can enunciate (e.g., through operation in conjunction of web navigation component 302 and/or dialogue flow component 304, as described above) the content included in user amendable prompt/bubble 404 (e.g., “Welcome Tim to Portal. What service would you like?”). Contents of user amendable prompt/bubble can be changed to any mnemonic device that the user desires. So for example, prompt/bubble can be changed from “Welcome Tim to Portal” to “Welcome Lord and Master to Portal”. Similarly, the phrase “What service would you like” can also be modified to “How can I be of service, Great Overlord?”, for instance. In addition, navigation pane 402 can include icon 406 that can depict (e.g., a thumbnail image) an associated application (e.g., web service such as Stock Market Quotes, or computer application such as a word processing application, and the like). Further navigation pane 402 can also include a user customizable prompt/bubble 408 that can indicate a response that the user will use (e.g., speak) in order to activate the application. It should be noted that the icon 406 and the application indicated in the customizable prompt/bubble can be associated with one another. Also as depicted, navigation pane 402 can include icon 410 that can represent an associated second application, in this case “My Application 2”, as well as an associated prompt/bubble 412 that can be personalized by users to reflect mnemonic devices of their choice to be affiliated with the prompt/bubble 412.

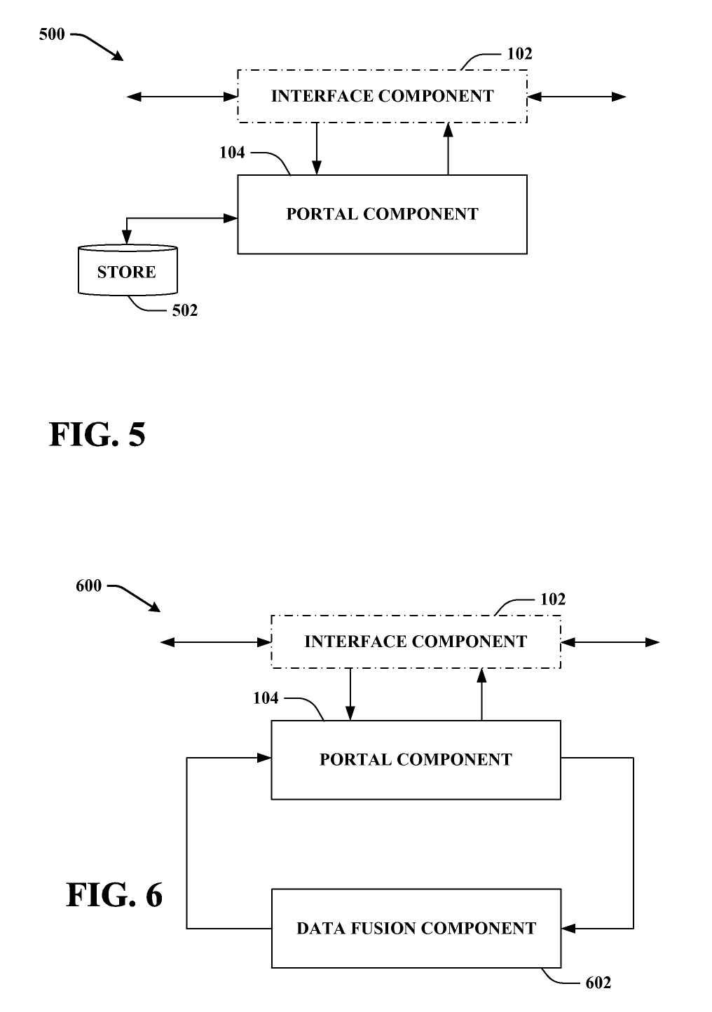

FIG. 5 depicts an aspect of a system 500 that effectuates and facilitates user development, customization, and/or utilization of dialogue flow systems in accordance with an aspect of the claimed subject matter. System 500 can include store 502 that can include any suitable data necessary for portal component 104 to facilitate and effectuate its aims. For instance, store 502 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate network, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information gleaned from the disparate network, ratings from a website, a credit score, geographical location, a donation to charity, or any other information related to software, applications, web conferencing, and/or any suitable data related to transactions, etc.

It is to be appreciated that store 502 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM) and Rambus dynamic RAM (RDRAM). Store 502 of the subject systems and methods is intended to comprise, without being limited to, these and any other suitable types of memory. In addition, it is to be appreciated that store 502 can be a server, a database, a hard drive, and the like.

FIG. 6 provides yet a further depiction of a system 600 effectuates and facilitates user development, customization, and/or utilization of dialogue flow systems in accordance with an aspect of the claimed subject matter. As depicted, system 600 can include a data fusion component 602 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by data fusion component 602 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

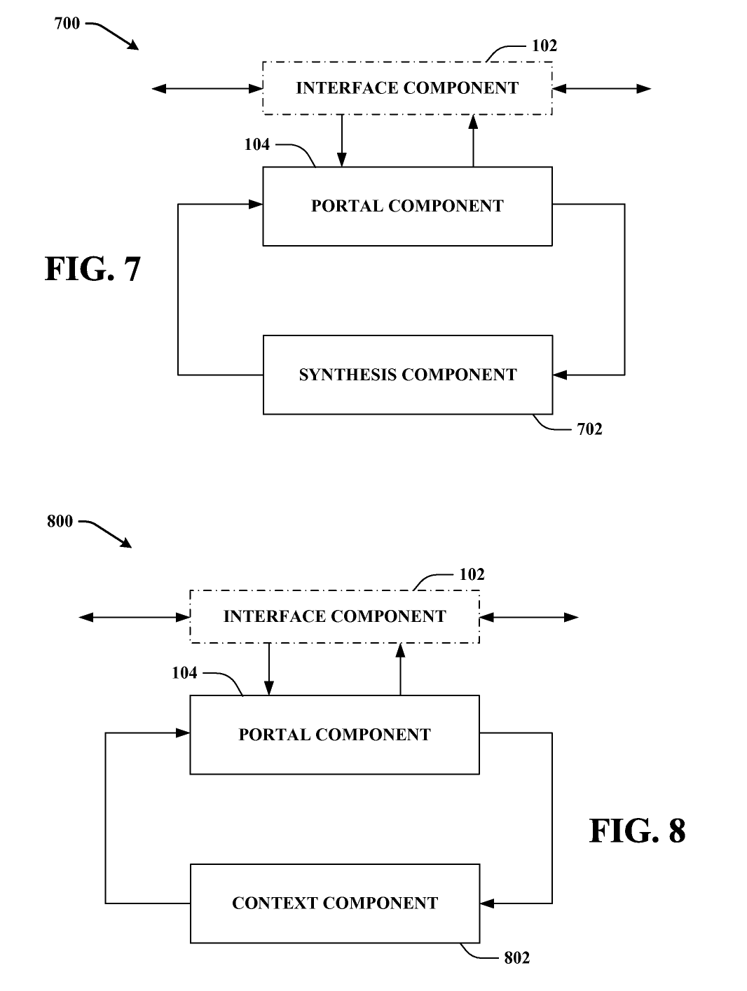

FIG. 7 provides a further depiction of a system 700 that effectuates and facilitates user development, customization, and/or utilization of dialogue flow systems in accordance with an aspect of the claimed subject matter. As illustrated portal component 104 can, for example, employ synthesis component 702 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Synthesis component 702 through combining and filtering can provide a set of information that can be more informative, or accurate (e.g., with respect to an entity's communicative or informational goals) and information from just one or two modalities, for example. As discussed in connection with FIG. 6, the data fusion component 602 can be employed to learn correlations between different data types, and the synthesis component 702 can employ such correlations in connection with combining, or filtering the input data.

FIG. 8 provides a further illustration of a system 800 that can effectuates and facilitates user development, customization, and/or utilization of dialogue flow systems in accordance with an aspect of the claimed subject matter. As illustrated portal component 104 can, for example, employ context component 802 to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component 802 can provide current or historical data in connection with inputs to increase proper interpretation of inputs. For example, time of day may be helpful to understanding an input—in the morning, the word “drink” would likely have a high a probability of being associated with coffee, tea, or juice as compared to be associated with a soft drink or alcoholic beverage during late hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, if the context component 802 had knowledge that the user was not camping, and that it was near dinnertime, the utterance would be interpreted as “steak”. On the other hand, if the context component 802 knew (e.g., via GPS system input) that the user recently arrived at a camping ground within a national park; it might more heavily weight the utterance as “stake”.

In view of the foregoing, it is readily apparent that utilization of the context component 802 to consider and analyze extrinsic information can substantially facilitate determining meaning of sets of inputs.

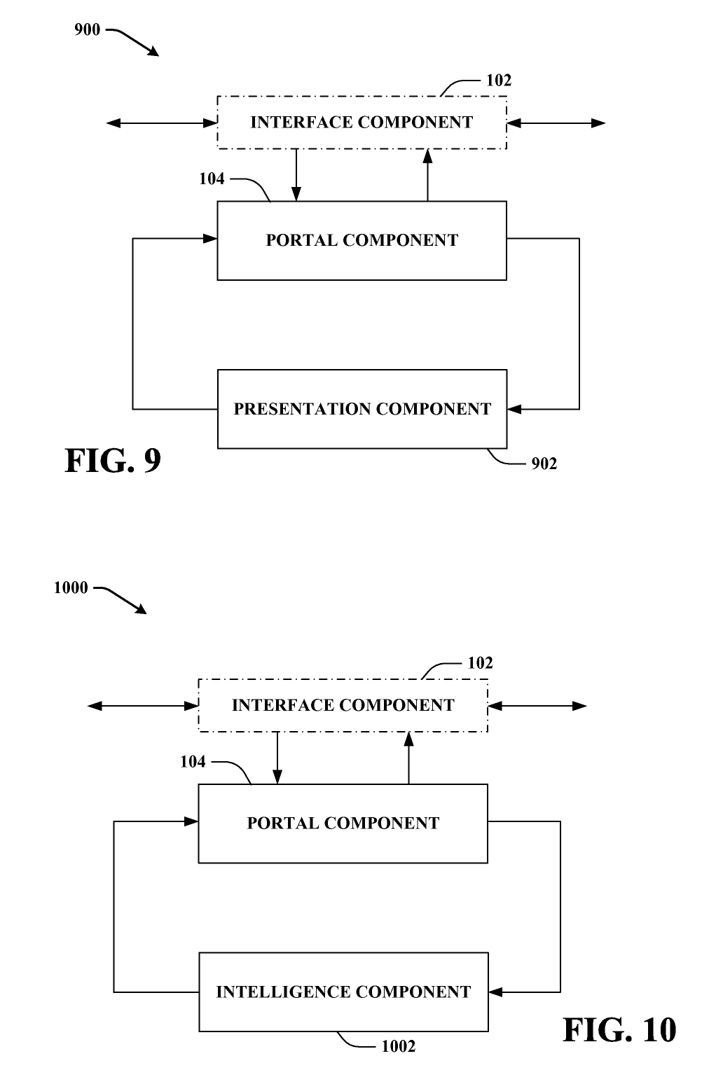

FIG. 9 a further illustration of a system 900 that effectuates and facilitates user development, customization, and/or utilization of dialogue flow systems in accordance with an aspect of the claimed subject matter. As illustrated, system 900 can include presentation component 902 that can provide various types of user interface to facilitate interaction between a user and any component coupled to portal component 104. As illustrated, presentation component 902 is a separate entity that can be utilized with portal component 104. However, it is to be appreciated that presentation component 902 and/or other similar view components can be incorporated into portal component 104 and/or a standalone unit. Presentation component 902 can provide one or more graphical user interface, command line interface, and the like. For example, the graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into portal component 104.

Users can also interact with regions to select and provide information via various devices such as a mouse, roller ball, keypad, keyboard, and/or voice activation, for example. Typically, the mechanism such as a push button or the enter key on the keyboard can be employed subsequent to entering the information in order to initiate, for example, a query. However, it is to be appreciated that the claimed subject matter is not so limited. For example, nearly highlighting a checkbox can initiate information conveyance. In another example, a command line interface can be employed. For example, the command line interface can prompt (e.g., via text message on a display and an audio tone) the user for information via a text message. The user can then provide suitable information, such as alphanumeric input corresponding to an option provided in the interface prompt or an answer to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

FIG. 10 depicts a system 1000 that employs artificial intelligence to effectuate and facilitate user development, customization, and/or utilization of dialogue flow systems in accordance with an aspect of the subject matter as claimed. Accordingly, as illustrated, system 1000 can include an intelligence component 1002 that can employ a probabilistic based or statistical based approach, for example, in connection with making determinations or inferences. Inferences can be based in part upon explicit training of classifiers (not shown) before employing system 100, or implicit training based at least in part upon system feedback and/or users previous actions, commands, instructions, and the like during use of the system. Intelligence component 1002 can employ any suitable scheme (e.g., numeral networks, expert systems, Bayesian belief networks, support vector machines (SVMs), Hidden Markov Models (HMMs), fuzzy logic, data fusion, etc.) in accordance with implementing various automated aspects described herein. Intelligence component 1002 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

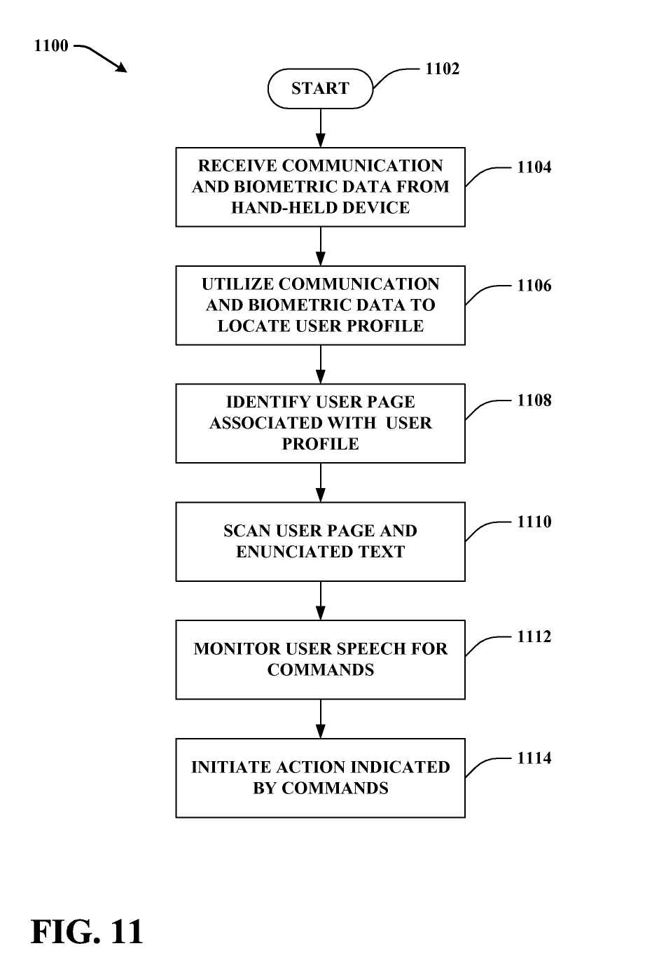

In view of the exemplary systems shown and described supra, methodologies that may be implemented in accordance with the disclosed subject matter will be better appreciated with reference to the flow chart of FIG. 11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 11 provides an illustrative methodology that can be implemented on a machine in accordance with an aspect of the claimed subject matter. At 1102 various and sundry initialization tasks can be performed after which method 1100 can proceed to 1104. At 1104 communication and biometric data can be obtained, received, solicited from hand-held devices, such as, for example, cell phones, laptop computers, consumer devices, personal digital assistants (PDAs), consumer electronic devices, multimedia Internet enabled phones, and the like. Communication and biometric data can include, but is not limited to, information regarding the handheld device being utilized (e.g., device type, device capabilities, hardware address, assigned network addresses, network addresses, . . . ) and data associated with the user of the handheld device. (e.g., voice samples, fingerprint impression, login ID, retinal scan sample, etc.). At 1106 communication and biometric data received, elicited, and/or solicited from users via associated hand held devices can be utilized to locate one or more user profile that can be automatically, dynamically, and/or contemporaneously generated, or additionally and/or alternatively can have been previously persisted to one or more storage facilities (e.g., databases, storage farms, and the like). At 1108 a user page associated with the determined user profile can be ascertained, typically such user profiles will provide indication as to the appropriate user page that should be utilized, but nevertheless, it should be noted that a user page can be automatically generated and thereafter associated with a user profile on the fly. At 1110 the user page associated with a particular user profile can be scanned for text at which point text can be converted to speech which can be conveyed to the hand held device for the user to hear. At 1112 method 1100 can listen for responses/utterances from the user and discern whether or not the user has enunciated a valid command (e.g., a command that is responsive to one or more items of text conveyed at 1110). At 1114 when a valid command has been detected, actions associated and indicated by the valid command can be initiated.

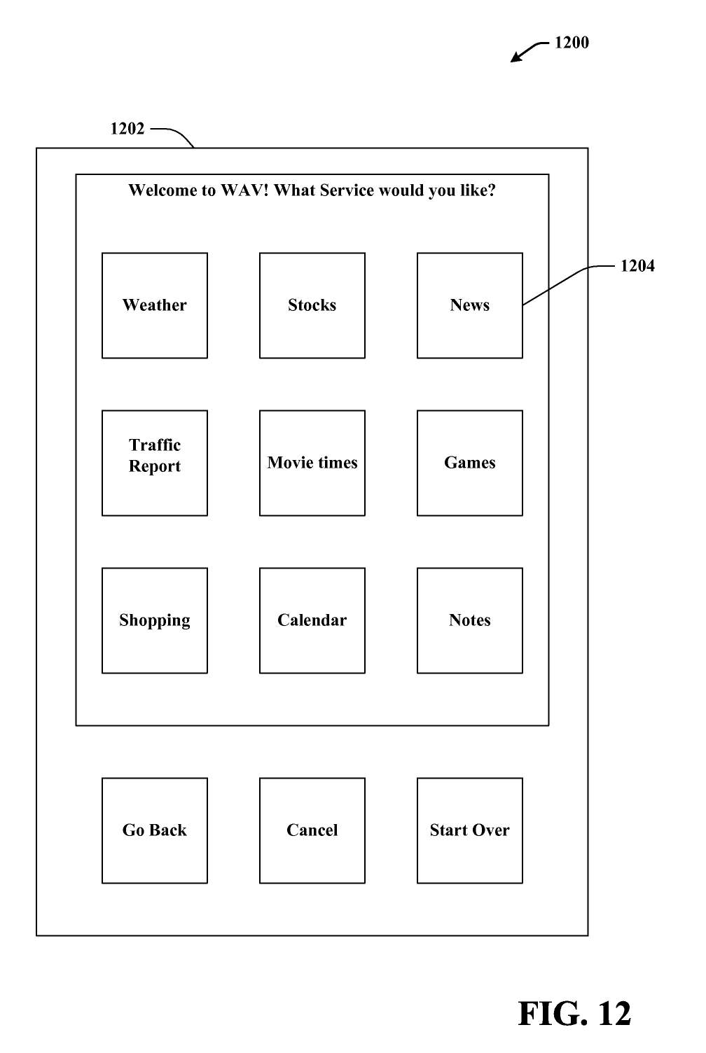

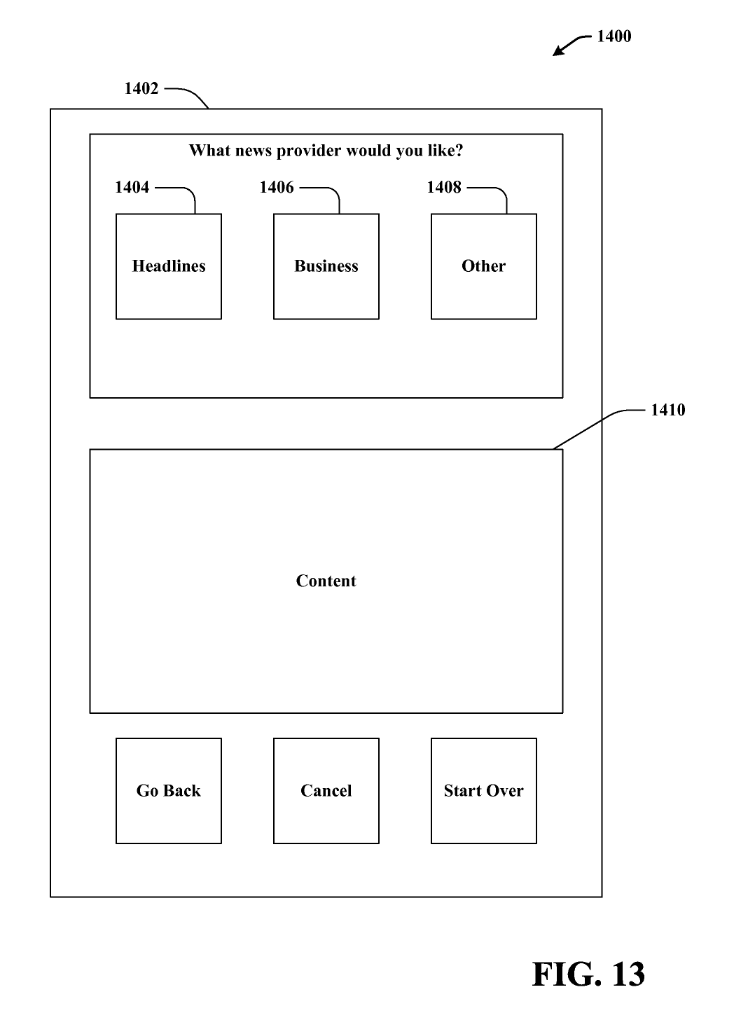

FIG. 12 provides illustration 1200 of a navigation pane 1202 that facilitates and effectuates user development, customization, or utilization of dynamic dialogue flow systems in accordance with one aspect of the claimed subject matter. As illustrated navigation pane 1202 can include multiple configurable and/or configured (e.g., pre-configured) selections, such as for example, News 1204. Other configurable and/or configured selectable items can include, for instance, items relating to weather, stocks, traffic reports, movie times, games, shopping, calendars, and notes. Additionally, user configured and/or configurable buttons can also be provided and displayed, for example, and as illustrated, go back button, cancel button, and start over button. Each selection or configurable button can be enunciated by the system when navigation pane 1202 is accessed. For example, the system can through use of web navigation component 302 and/or dialogue flow component 304, as described above, can enunciate “News” in connection with selection News 1204. Moreover, the system can listen for a user to utter “News” in connection with selection 1204, at which point the system can transition to a more detailed navigation pane (e.g., FIG. 13) which can permit the user to access further configurable and/or configured selectable items associated with “News”.

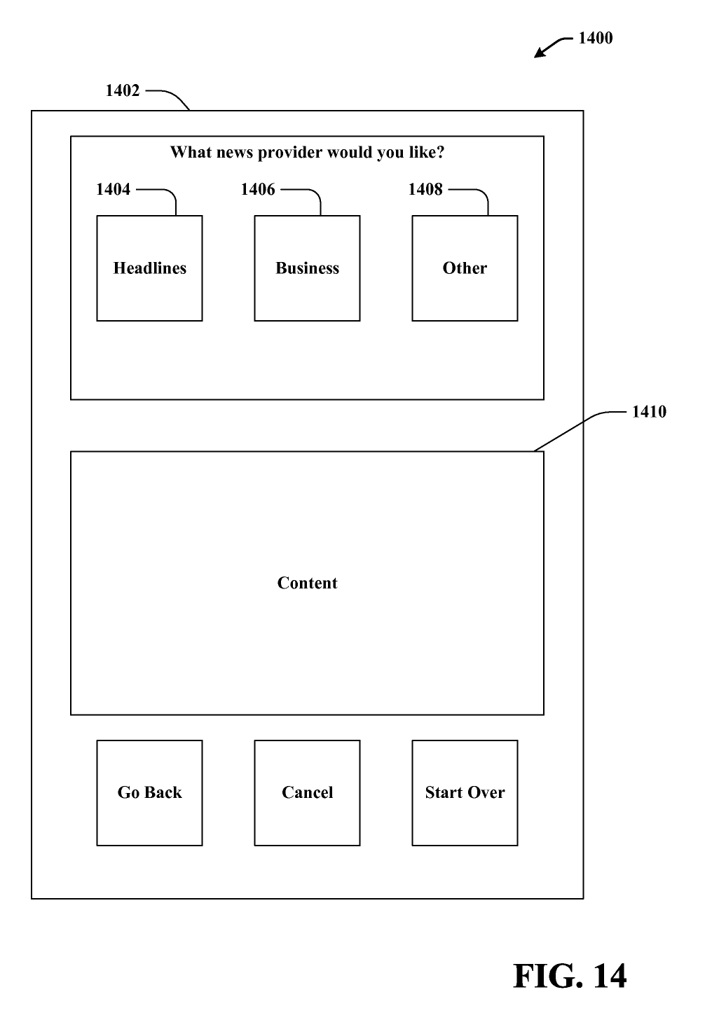

FIG. 13 provides further illustration 1300 of a navigation pane 1302 that effectuates and facilitates user development, customization, or utilization of dialogue flow systems in accordance with an aspect of the claimed subject matter. As stated above, navigation pane 1302 can be associated with user configurable and/or configured selection News 1204 (e.g., FIG. 12) and can provide further selections related to news and news services (e.g., CNN, BBC World News, ABC News, NPR, Reuter, and the like). When navigation pane 1302 is accessed the system can articulate the various selections and buttons presented within navigation pane 1302, including the phrase “What news provider would you like?” Additionally and/or alternatively, the system can listen for a user to verbalize the desired selection. For example, the user can vocalize the selection “News Service 6” 1304, at which point the system can transition to a more detailed navigation pane (e.g., FIG. 14) which can permit the user to access further configurable and/or configured selectable items associated with “News Service 6”. Alternatively, the user can utilize user configured and/or configurable buttons, such as, for example, the go back button, cancel button, and/or start over button by enunciating “Go Back”, “Cancel”, or “Start Over”.

FIG. 14 provides illustration 1400 of a navigation pane 1402 that facilitates and effectuates user development, customization, or utilization of dynamic dialogue flow systems in accordance with one aspect of the claimed subject matter. Navigation pane 1402 can include further configurable and/or configured selections, items, and/or buttons. For example, navigation pane 1402 can include configurable and/or configured selections relating to Headlines 1404, Business 1406, and Other 1408 wherein utilization (e.g., through user utterances) of Headlines 1404 can cause news headlines to be display in content pane 1410. Similarly, employment of Business 1406 can cause business news to be presented in content pane 1410. Moreover, other news category items (e.g., sports, politics, local news, etc.) can be included in the Other 1408 selection.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g., methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

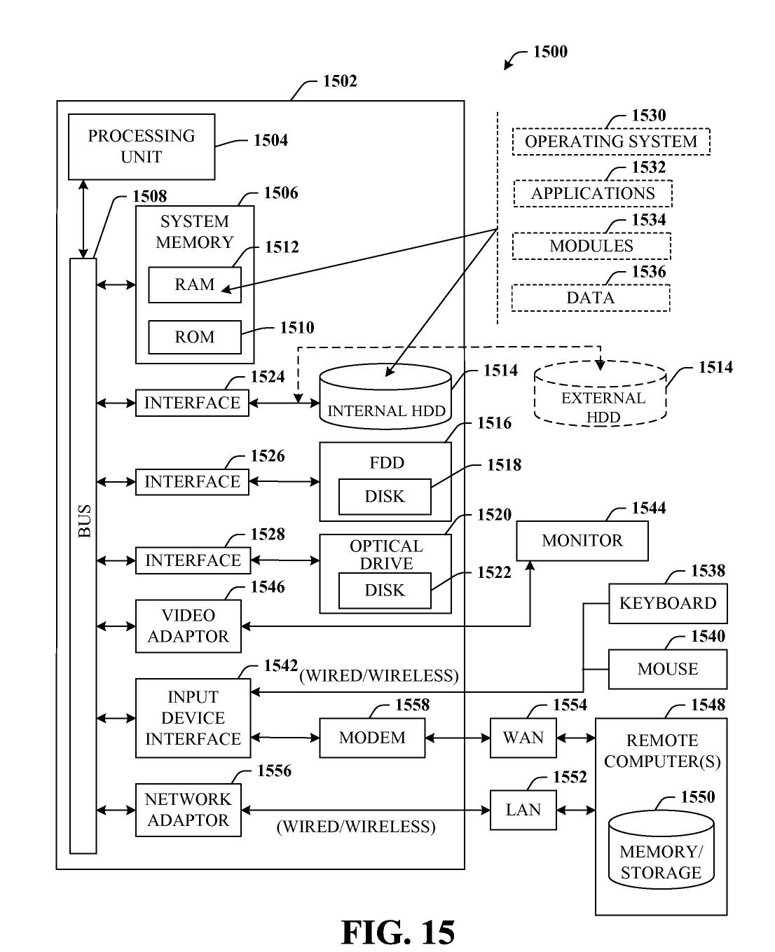

Referring now to FIG. 15, there is illustrated a block diagram of a computer operable to execute the disclosed system. In order to provide additional context for various aspects thereof, FIG. 15 and the following discussion are intended to provide a brief, general description of a suitable computing environment 1500 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 15, the exemplary environment 1500 for implementing various aspects includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1294 interface technologies. Other external drive connection technologies are within contemplation of the claimed subject matter.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is to be appreciated that the claimed subject matter can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1294 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adaptor 1556 may facilitate wired or wireless communication to the LAN 1552, which may also include a wireless access point disposed thereon for communicating with the wireless adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

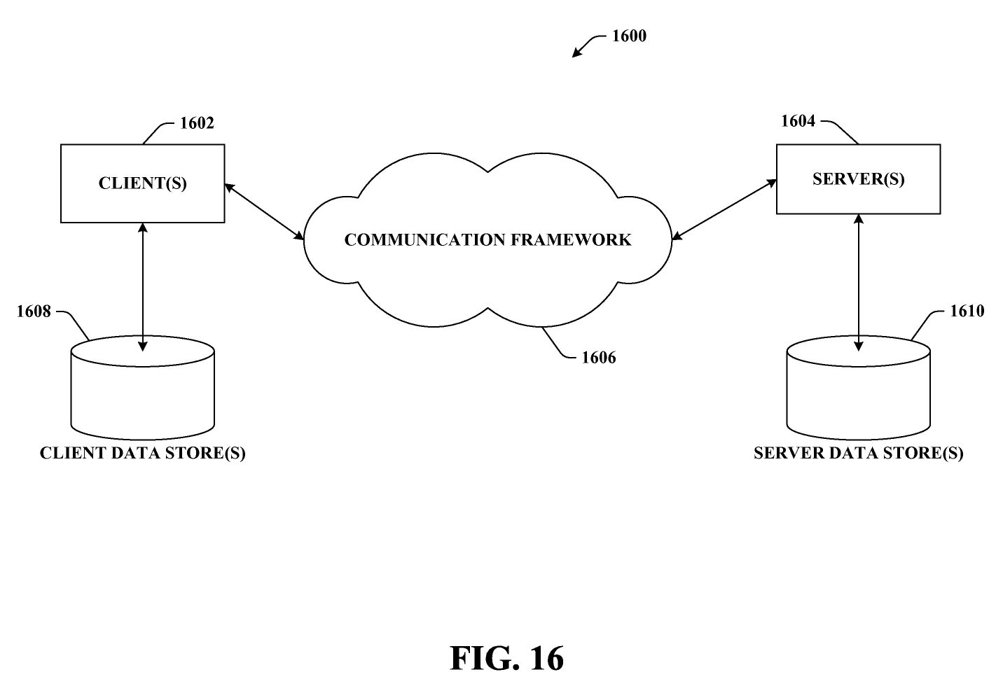

Referring now to FIG. 16, there is illustrated a schematic block diagram of an exemplary computing environment 1600 for processing the disclosed architecture in accordance with another aspect. The system 1600 includes one or more client(s) 1602. The client(s) 1602 can be hardware and/or software (e.g., threads, processes, computing devices). The client(s) 1602 can house cookie(s) and/or associated contextual information by employing the claimed subject matter, for example.

The system 1600 also includes one or more server(s) 1604. The server(s) 1604 can also be hardware and/or software (e.g., threads, processes, computing devices). The servers 1604 can house threads to perform transformations by employing the claimed subject matter, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that facilitates and effectuates at least one of user development, customization, or utilization of a dynamically configurable dialogue flow system, comprising:
a component that solicits from an interface data associated with a web service, a speech service, a mobile device, or a user, the component utilizes the data associated with the user to retrieve navigation panes unique with respect to the user, the component scans the navigation panes and identifies adjustable attributes, the adjustable attributes utilized by the component to generate voice prompts conveyed to the user, the user in reply utters personalized responses associated with the voice prompts, the component initiates actions associated with the adjustable attributes based at least in part on the uttered personalized responses.

2. The system of claim 1, wherein the component utilizes data associated with the mobile device to associate the user with the navigation panes.

3. The system of claim 1, wherein the user supplies authentication data via the mobile device to effectuate communication with the component.

4. The system of claim 3, wherein the authentication data includes biometric information associated with the user.

5. The system of claim 4, wherein the biometric data includes at least one of voice pattern samples, finger print impressions, or retinal scans.

6. The system of claim 1, wherein the mobile device includes at least one of personal digital assistants, cell phones, multimedia Internet enable devices, or laptop computers.

7. The system of claim 1, wherein the navigation panes provide a dataflow that effectuates a verbal dialogue flow conveyed to the user.

8. The system of claim 1, wherein the voice prompts generated by a text to speech converter.

9. The system of claim 1, wherein the actions associated with the adjustable attributes relates to the web service to which the user currently subscribes.

10. The system of claim 1, wherein the user utilizes the web service or the speech service to amend the adjustable attributes where the user visually manipulates the adjustable attributes through the web service or the speech service.

11. The system of claim 1, wherein the adjustable attributes are automatically included in a grammar associated with the dynamically configurable dialogue flow system where the dynamically configurable dialogue flow system includes a telephony system where the user utilizes a telephony number to access a personalized dialogue flow.

12. The system of claim 1, wherein the component effectuates correspondence between the web service and the speech service based at least in part on the adjustable attributes.

13. The system of claim 1, wherein the component utilizes data associated with the user or the mobile device to register the user to the dynamically configurable dialogue flow system.

14. The system of claim 1, wherein the component associates a unique randomly selected identifier to the user.

15. A machine implemented method that facilitates and effectuates at least one of development, personalization, or utilization of dynamically adjustable dialogue flow systems, comprising:
receiving communication and biometric data from a hand-held device;
utilizing the communication and biometric data to locate a user profile;
identifying a user page associated with the user profile;
scanning the user page associated with the user profile;
enunciating text associated with the user page;
monitoring user speech for a verbal prompt and
initiating an action associated with the verbal prompt based at least in part on the user speech responsive to the verbal prompt.

16. The method of claim 15, further comprising retrieving navigation panes based at least in part on authentication information supplied by a user via the hand-held device.

17. The method of claim 16, the navigation panes provide a dynamically adjustable dataflow uniquely associated with the user.

18. The method of claim 15, further includes employing web services to customize adjustable attributes to a user preference.

19. The method of claim 15, further includes identifying the user based at least in part on data personal to the user or data related to the hand-held device employed by the user to communicate with the dynamically adjustable dialogue flow systems.

20. A system that effectuates construction, customization, or use of a configurable dialogue flow system, comprising:
means for scanning navigation panes associated with a user, the navigation panes include user amendable attributes;
means for generating audio prompts based at least in part on the user amendable attributes;
means for conveying the audio prompts to the user via a means for communications;
means for acquiring and recognizing speech responsive to the audio prompts; and
based at least on the speech responsive to the audio prompts, employing means for initiating an action associated with the user amendable attributes.
